(19) United States
(12) Patent Application Publication
(10) Pub. No.: US 2006/0080098 A1
(43) Pub. Date: Apr. 13, 2006

(54) Apparatus and method for speech processing using paralinguistic information in vector form

(76) Inventor: Nick Campbell, Soraku-gun (JP)

Correspondence Address: HARNESS, DICKEY & PIERCE, P.L.C., P.O. BOX 8910, RESTON, VA, 20195, US

(21) Appl. No.: 11/238,044

(22) Filed: Sep. 29, 2005

(30) Foreign Application Priority Data
Sep. 30, 2004 (JP) 2004-287943(P)

(51) Int. Cl. G10L 15/06

(52) U.S. Cl. 704/243

(57) ABSTRACT

A speech processing apparatus includes a statistics collecting module operable to collect, for each of a prescribed utterance units of a speech in a training speech corpus, a prescribed type of acoustic feature and statistic information on a plurality of paralinguistic information labels being selected by a plurality of listeners to a speech corresponding to the utterance unit; and a training apparatus trained by supervised machine training using said prescribed acoustic feature as input data and using the statistic information as answer data, to output probability of allocation of the label to a given acoustic feature, for each of said plurality of paralinguistic information labels, forming a paralinguistic information vector.

### CROSS-REFERENCE TO RELATED APPLICATION

This application is based upon and claims the benefit of priority from the prior Japanese Patent Application No. 2004-287943, filed Sep. 30, 2004, the entire contents of which are incorporated herein by reference.

### BACKGROUND OF THE INVENTION

1. Field of the Invention

The present invention relates to a speech processing technique and more specifically, to a speech processing technique allowing appropriate processing of paralinguistic information other than prosody.

2. Description of the Background Art

People display affect in many ways. In speech, changes in speaking style, tone-of-voice, and intonation are commonly used to express personal feelings, often at the same time as imparting information. How to express or understand such a feeling is a challenging problem in speech processing technique using a computer.

In “Listening between the lines: a study of paralinguistic information carried by tone-of-voice”, in Proc. International Symposium on Tonal Aspects of Languages, TAL2004, pp. 13-16, 2004; “Getting to the heart of the matter”, Keynote speech in Proc. Language Resources and Evaluation Conference (LREC-04), 2004, (http://feast.his.atr.jp/nick/pubs/lrec-keynote.pdf); “Extra-Semantic Protocols: Input Requirements for the Synthesis of Dialogue Speech” in Affective Dialogue Systems, Eds. Andre, E., Dybkjaer, L., Minker, W., & Heisterkamp, P., Springer Verlag, 2004, it has been proposed by the inventor of the present invention that speech utterances can be categorized into two main types for the purpose of automatic analysis: I-type and A-type. I-type are primarily information-bearing, and A-type serve primarily for the expression of affect. The I-type can be well characterized by the text of their transcription alone, while the A-type tend to be much more ambiguous and require a knowledge of their prosody before an interpretation of their meaning can be made.

By way of example, in “Listening between the lines: a study of paralinguistic information carried by tone-of-voice” and “What do people hear? A study of the perception of non-verbal affective information in conversational speech”, in Journal of the Phonetic Society of Japan, vol. 7, no. 4, 2004, looking at the (Japanese) utterance “Eh”, the inventor has found that listeners are consistent in assigning affective and discourse-functional labels to interjections heard in isolation without contextual discourse information. Although there was some discrepancy in the exact labels selected by the listeners, there was considerable agreement in the dimensions of perception. This ability seems to be also language- and culture-independent as Korean and American listeners were largely consistent in attributing “meanings” to the same Japanese utterances.

However, there arises a difficult problem when paralinguistic information associated with an utterance, for example, is to be processed by natural language processing by a computer. For instance, one same utterance in text may express quite different meanings in different situations, or it may express totally different sentiment simultaneously. In such a situation, it is very difficult to take out paralinguistic information only from acoustic features of the utterance.

One solution to such a problem is to label an utterance in accordance with the paralinguistic information a listener senses when he/she listens to an utterance

Different listeners, however, may differently understand contents of an utterance. This leads to a problem that labeling will not be reliable if it depends only on a specific listener.

### SUMMARY OF THE INVENTION

Therefore, an object of the present invention is to provide a speech processing apparatus and a speech processing method that can appropriately process paralinguistic information.

Another object of the present invention is to provide a speech processing apparatus that can widen the scope of application of speech processing, through better processing of paralinguistic information.

According to one aspect of the present invention, a speech processing apparatus includes: a statistics collecting module operable to collect, for each of a prescribed utterance units in a training speech corpus, a prescribed type of acoustic feature and statistic information on a plurality of predetermined paralinguistic information labels being selected by a plurality of listeners to speech corresponding to the utterance unit; and a training apparatus trained by supervised machine training using the prescribed acoustic feature as input data and using the statistic information as answer (training) data, to output probabilities of the labels being allocated to a given acoustic feature.

The training apparatus is trained based on statistics, such that the percentage of each of a plurality of labels of paralinguistic information being allocated to a given acoustic feature is output. The paralinguistic information label has the plurality of values. A single label is not allocated to the utterance. Rather, the paralinguistic information is given as probabilities for a plurality of labels being allocated, and therefore, the real situation where different persons obtain different kinds of paralinguistic information from the same utterance can be well reflected. This leads to better processing of paralinguistic information. Further, this makes it possible to extract complicated meanings as paralinguistic information from one utterance, and to broaden the applications of speech processing.

Preferably, the statistics collecting module includes a module for calculating a prescribed type of acoustic feature for each of the prescribed utterance units in the training speech corpus; a speech reproducing apparatus for reproducing speech corresponding to the utterance unit, for each of the prescribed utterance units in the training speech corpus; a label specifying module for specifying a paralinguistic information label allocated by a listener to the speech reproduced by the speech reproducing apparatus; and a probability calculation module for calculating, for each of the plurality of paralinguistic information labels, probability of each of the plurality of paralinguistic information labels being allocated to the prescribed utterance units in the training corpus, by reproducing, for each of a plurality of listeners, an utterance by the speech reproducing apparatus and specification of paralinguistic information label by the label specifying module.

Further preferably, the prescribed utterance unit is most likely to be a syllable, but may be a phoneme.

According to a second aspect of the present invention, a speech processing apparatus includes: an acoustic feature extracting module operable to extract a prescribed acoustic feature from an utterance unit of an input speech data; a paralinguistic information output module operable to receive the prescribed acoustic feature from the acoustic feature extracting module and to output a value corresponding to each of a predetermined plurality of types of paralinguistic information as a function of the acoustic feature; and an utterance intention inference module operable to infer utterance intention of a speaker related to the utterance unit of the input utterance data, based on a set of values output from the paralinguistic information output module.

The acoustic feature is extracted from an utterance unit of the input speech data, and as a function of the acoustic feature, a value is obtained for each of the plurality of types of paralinguistic information. Training that infers intention of the utterance by the speaker based on the set of these values becomes possible. As a result, it becomes possible to infer the intention of a speaker from an actually input utterance.

According to a third aspect of the present invention, a speech processing apparatus includes: an acoustic feature extracting module operable to extract, for each of prescribed utterance units included in a speech corpus, a prescribed acoustic feature from acoustic data of the utterance unit; a paralinguistic information output module operable to receive the acoustic feature extracted for each of the prescribed utterance units from the acoustic feature extracting module, and to output, for each of a predetermined plurality of types of paralinguistic information labels, a value as a function of the acoustic feature; and a paralinguistic information addition module operable to generate a speech corpus with paralinguistic information, by additionally attaching a value calculated for each of the plurality of types of paralinguistic information labels by the paralinguistic information output module to the acoustic data of the utterance unit.

According to a fourth aspect of the present invention, a speech processing apparatus includes: a speech corpus including a plurality of speech waveform data items each including a value for each of a prescribed plurality of types of paralinguistic information labels, a prescribed acoustic feature including a phoneme label, and speech waveform data; waveform selecting module operable to select, when a prosodic synthesis target of speech synthesis and a paralinguistic information target vector having an element of which value is determined in accordance with an intention of utterance are applied, a speech waveform data item having such acoustic feature and paralinguistic information vector that satisfy a prescribed condition determined by the prosodic synthesis target and the paralinguistic information target vector, from the speech corpus; and a waveform connecting module operable to output a speech waveform by connecting the speech waveform data included in the speech waveform data item selected by the waveform selecting module in accordance with the synthesis target.

According to a fifth aspect of the present invention, a speech processing method includes the steps of: collecting, for each of a prescribed utterance units in a training speech corpus, a prescribed type of acoustic feature and statistic information on a plurality of predetermined paralinguistic information labels being selected by a plurality of listeners to speech corresponding to the utterance unit; and training, by supervised machine training using the prescribed acoustic feature as input data and using the statistic information as answer (training) data, to output probabilities of the labels being allocated to a given acoustic feature for each of the plurality of paralinguistic information labels.

According to a sixth aspect of the present invention, a speech processing method includes the steps of: extracting a prescribed acoustic feature from an utterance unit of an input speech data; applying the prescribed acoustic feature extracted in the step of extracting, to a paralinguistic information output module operable to output a value for each of a predetermined plurality of types of paralinguistic information as a function of the acoustic feature, to obtain a value corresponding to each of the plurality of types of paralinguistic information; and inferring, based on a set of values obtained in the step of obtaining, intention of utterance by a speaker related to the utterance unit of the input speech data.

According to a seventh aspect of the present invention, a speech processing method includes the steps of: extracting, for each of prescribed utterance units included in a speech corpus, a prescribed acoustic feature from acoustic data of the utterance unit; receiving the acoustic feature extracted for each of the prescribed utterance units in the extracting step, and calculating, for each of a predetermined plurality of types of paralinguistic information labels, a value as a function of the acoustic feature; and generating a speech corpus with paralinguistic information, by attaching, for every prescribed utterance unit, the value calculated for each of the plurality of types of paralinguistic information labels calculated in the calculating step to acoustic data of the utterance unit.

According to an eighth aspect of the present invention, a speech processing method includes the steps of: preparing a speech corpus including a plurality of speech waveform data items each including a value corresponding to each of a prescribed plurality of types of paralinguistic information labels, a prescribed acoustic feature including a phoneme label, and speech waveform data; in response to a prosodic synthesis target of speech synthesis and a paralinguistic information target vector having an element of which value is determined in accordance with utterance intention, selecting a speech waveform data item having such acoustic feature and paralinguistic information vector that satisfy a prescribed condition determined by the prosodic synthesis target and the paralinguistic information target vector, from the speech corpus; and connecting speech waveform data included in the speech waveform data item selected in the selecting step in accordance with the synthesis target, to form a speech waveform.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of speech understanding system 20 in accordance with the first embodiment of the present invention.

FIG. 2 is a block diagram of a classification tree training unit 36 shown in FIG. 1.

FIG. 3 is a block diagram of a speech recognition apparatus 40 shown in FIG. 1.

FIG. 4 is a block diagram of a speech corpus labeling apparatus 80 in accordance with a second embodiment of the present invention.

FIG. 5 schematically shows a configuration of speech data 110 in speech corpus 90.

FIG. 6 is a block diagram of a speech synthesizing apparatus 142 in accordance with a third embodiment of the present invention.

FIG. 7 shows an appearance of computer system 250 implementing speech understanding system 20 and the like in accordance with the first embodiment of the present invention.

FIG. 8 is a block diagram of computer 260 shown in FIG. 7.

### DESCRIPTION OF THE PREFERRED EMBODIMENTS

[Outline]

For the labeling of affective information in speech, we find that different people are sensitive to different facets of information, and that, for example, a question may function as a back-channel, and a laugh may show surprise at the same time as revealing that the speaker is also happy. A happy person may be speaking of a sad event and elements of both (apparently contradictory) emotions may be present in the speech at the same time.

In view of the foregoing, labeling of a speech utterance using a plurality of labels would be more reasonable than labeling of a speech utterance using only one limited label. Therefore, in the following description of an embodiment, a plurality of different labels are prepared. A numerical value representing the statistical ratio as to which label is selected to which utterance unit of speech by different persons is given as a vector element, and each utterance is labeled by the vector. In the following, the vector will be referred to as a “paralinguistic information vector.”

### First Embodiment

—Configuration—

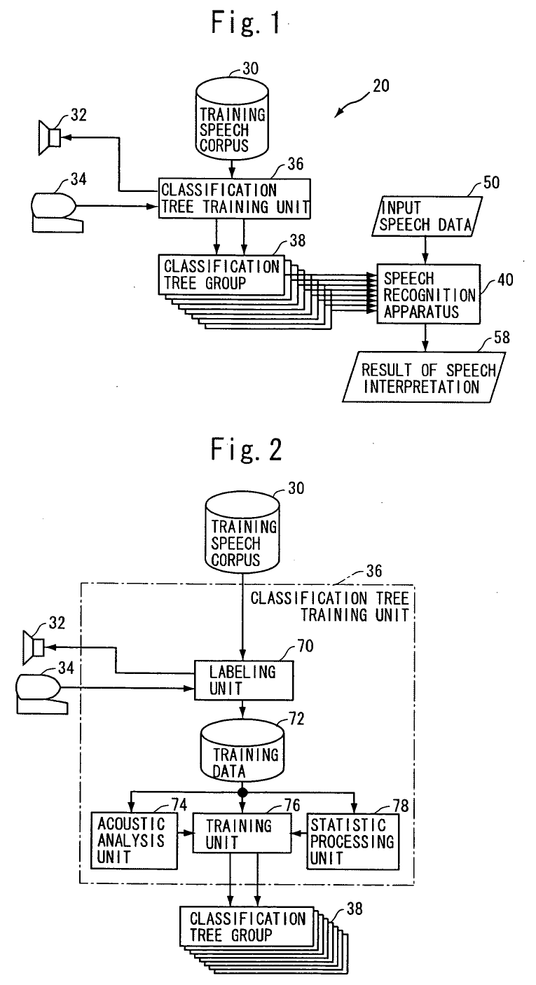

FIG. 1 is a block diagram of a speech understanding system 20 in accordance with the first embodiment of the present invention. Referring to FIG. 1, speech understanding system 20 uses a classification tree group 38 that determines, for each element of the paralinguistic information vector, the probability that the label will be allocated to an utterance of interest, when a predetermined type of acoustic information of the utterances is given. Classification tree group 38 includes classification trees corresponding in number to the elements forming the paralinguistic information vector. The first classification tree outputs a probability that the first element label will be allocated, the second classification tree outputs a probability that the second element label will be allocated, and so on. In the present embodiment, it is assumed that the value of each element of paralinguistic information vector is normalized in the range of [0, 1].

Noted that speech understanding system 20 described below can be realized by computer hardware and a computer program executed by the computer hardware, as will be described later. Each of the blocks described in the following can be realized as a program module or a routine providing a required function.

Referring to FIG. 1, speech understanding system 20 includes a training speech corpus 30, and a classification tree training unit 36 connected to a speaker 32 and an input apparatus 34, for collecting statistical data as to which labels are allocated by a prescribed number of subjects when each phoneme of speech in training speech corpus 30 is reproduced, and for performing training of each classification tree in classification tree group, based on the collected data. The classification trees in classification tree group 38 are provided corresponding to the label types. By the training of classification tree training unit 36, each classification tree in classification tree group 38 is trained to output, when acoustic information is given, a probability of the prescribed subjects selecting the corresponding labeling.

Speech understanding system 20 further includes a speech recognition apparatus 40 that performs speech recognition on a given input speech data 50, performs speech understanding including affects expressed by input speech data 50 using classification tree group 38, and outputs result of speech interpretation 58 including recognition text and utterance intention information representing intention of the speaker of input speech data 50.

Referring to FIG. 2, classification tree training unit 36 includes a labeling unit 70 for collecting, as statistical information for training, the labels allocated by the subjects to the speech of training speech corpus 30, together with the corresponding training data. The speech of training speech corpus 30 is reproduced by speaker 32. The subject allocates a label to the speech, and gives the label to classification tree training unit 36 using an input apparatus 34.

Classification tree training unit 36 further includes: training data storing unit 72 for storing training data accumulated by labeling unit 70; an acoustic analysis unit 74 performing acoustic analysis on utterance data among training data stored in training data storing unit 72 and outputting prescribed acoustic features; and statistic processing unit 78 statistically processing the ratio of which label is allocated to which phoneme by the subjects, among the training data stored in training data storing unit 72.

Classification tree training unit 36 further includes a training unit 76 for training each classification tree in classification tree group 38 by supervised machine learning, using the acoustic features from acoustic analysis unit 74 as training data, and the probability of a specific label corresponding to the classification tree being allocated to the speech as the answer (training) data. By the training of classification tree training unit 36, classification tree group 38 will learn to output statistical information optimized for given acoustic features. Specifically, when acoustic features of a certain speech is applied, classification tree group 38 learns to infer and to output a likely value as the probability of each of the labels being allocated to the speech by the subjects.

Though only one classification tree training unit 36 is shown for classification tree group 38, there are such functional units equal in number as the classification trees, and for each classification tree in classification tree group 38, training is performed on label statistics, so that the probability of the corresponding label being selected by the listener is inferred based on the statistical information.

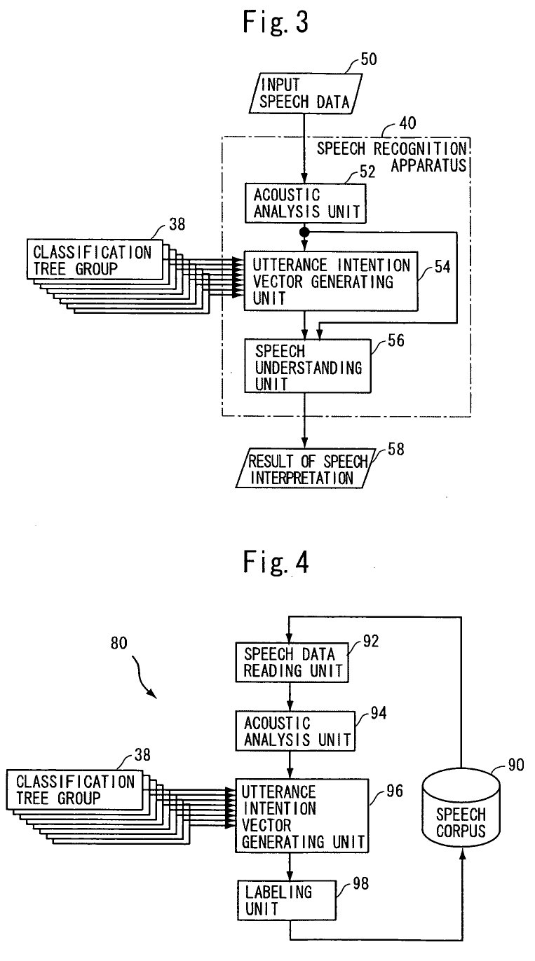

Referring to FIG. 3, speech recognition apparatus 40 includes: an acoustic analysis unit 52 for acoustically analyzing the input speech data 50 in the same manner as acoustic analysis unit 74 and for outputting acoustic features; utterance intention vector generating unit 54 for applying the acoustic features output from acoustic analysis unit 52 to each classification tree of classification tree group 38, arranging the label probabilities returned from respective classification trees in a prescribed order to infer intention of the speaker of input speech data 50, and generating paralinguistic information vector (referred to as “utterance intention vector” in the embodiments) representing the intention (meaning of utterance) of the speaker; and a speech understanding unit 56 for receiving the utterance intention vector from unit 54 and the acoustic features from acoustic analysis unit 52, performing speech recognition and understanding meanings, and outputting the result of speech interpretation 58. Speech understanding unit 56 can be realized by a meaning understanding model trained in advance using, as inputs, the training speech corpus, utterance intention vector corresponding to each utterance of the training speech corpus and the result of understanding the meaning of the speech by the subject.

—Operation—

The operation of speech understanding system 20 has two phases. The first is training of classification tree group 38 by classification tree training unit 36. The second is operation in which speech recognition apparatus 40 understands the meaning of input speech data 50 based on the classification tree group 38 trained in the above-described way. In the following, these phases will be described in order.

Training Phase

It is assumed that training speech corpus 30 is prepared prior to the training phase. It is also assumed that a prescribed number of subjects (for example, 100 subjects) are preselected, and that a prescribed number of utterances (for example, 100 utterances) are defined as training data.

Labeling unit 70 shown in FIG. 2 takes out a first utterance from training speech corpus 30 and reproduces it using speaker 32, for the first subject. The subject selects paralinguistic information he/she sensed on the reproduced speech to any one of the predetermined plurality of labels, and applies the selected label to labeling unit 70 through input apparatus 34. Labeling unit 70 accumulates the label allocated by the first subject to the first utterance together with information specifying the speech data, in training data storing unit 72.

Labeling unit 70 further reads the next utterance from training speech corpus 30, and performs the similar operation as described above on the first subject. Similar operation continues.

By the above-described process performed on the first subject using all the training utterances, pieces of information can be accumulated as to which label was allocated to which phoneme of each training utterance by the first subject.

By repeating such a process on all the subjects, pieces of information as to which label is allocated how many times to each training utterance can be accumulated.

When the above-described process ends on all the subjects, classification tree group 38 may be trained in the following manner. Acoustic analysis unit 74 acoustically analyzes every utterance, and applies resultant acoustic features to training unit 76. Statistic processing unit 78 performs a statistic processing to find out the probabilities of the labels being allocated, to each of the phonemes of all utterances, and applies the results to training unit 76.

Training unit 76 trains each classification tree included in classification tree group 38. At this time, the acoustic features of phonemes of each utterance from acoustic analysis unit 74 are used. As the answer (training) data, probability of the label corresponding to the classification tree of interest being allocated to the utterance is used. When this training ends on all the utterances, understanding of speech by speech recognition apparatus 40 becomes possible.

Operation Phase

Referring to FIG. 3, given speech data 50 in the operation phase, acoustic analysis unit 52 acoustically analyzes the utterance, extracts acoustic features and applies them to utterance intention vector generating unit 54 and speech understanding unit 56. Utterance intention vector generating unit 54 applies the acoustic features from acoustic analysis unit 52 to each of the classification trees of classification tree group 38. Each classification tree outputs the probability of the corresponding label being allocated to the utterance, and returns it to unit 54.

Unit 54 generates utterance intention vector having the received probabilities as elements in a prescribed order for each label, and gives the vector to speech understanding unit 56.

Based on the acoustic features from unit 52 and on the utterance intention vector from unit 54, speech understanding unit 56 outputs a prescribed number of speech interpretation results 58 having highest probabilities of combinations of recognized texts of input speech data 50 and utterance intention information representing the intention of the speaker of input speech data 50.

As described above, speech understanding system 20 of the present invention is capable of performing not only the speech recognition but also semantic understanding of input utterances, including understanding of the intention of the speaker behind the input speed data.

In the present embodiment, classification trees are used for training from training speech corpus 30. The present invention, however, is not limited to such an embodiment. An arbitrary machine training such as neural networks, Hidden Markov Models (HMM) or the like may be used in place of the classification trees. The same applies to the second embodiment described in the following.

### Second Embodiment

The system in accordance with the first embodiment enables semantic understanding of input speech data 50. Using classification tree group 38 and the principle of operation of the system, it is possible to label each utterance included in a given speech corpus with an utterance intention vector representing semantic information. FIG. 4 shows a schematic configuration of a speech corpus labeling apparatus 80 for this purpose.

Referring to FIG. 4, speech corpus labeling apparatus 80 includes: classification tree group 38, which is the same as that used in the first embodiment; a speech data reading unit 92 for reading speech data from speech corpus 90 as the object of labeling; an acoustic analysis unit 94 for acoustically analyzing the speech data read by speech data reading unit 92 and outputting resultant acoustic features; an utterance intention vector generating unit 96 for applying the acoustic feature from acoustic analysis unit 94 to each classification tree of classification tree group 38, and for generating an utterance intention vector having elements, which are the probabilities returned from respective classification trees arranged in a prescribed order; and a labeling unit 98 for labeling the corresponding utterance in speech corpus 90 with the utterance intention vector generated by unit 96,.

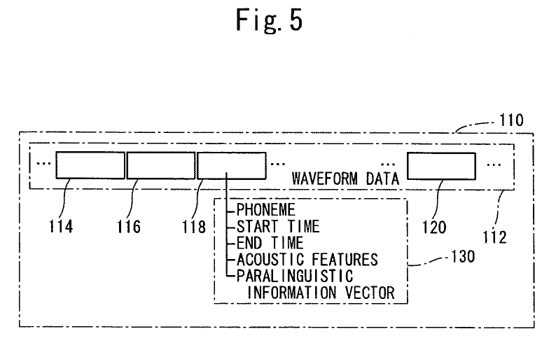

FIG. 5 shows a configuration of speech data 110 included in speech corpus 90. Referring to FIG. 5, speech data 110 includes waveform data 112 of speech. Waveform data 112 includes utterance waveform data 114, 116, 118, . . . 120, . . . and so on.

Each of utterance waveform data, utterance waveform data 118 for example, has prosodic information 130. Prosodic information 130 includes phoneme represented by utterance waveform data 118, start time and end time of utterance waveform data 118 measured from the start of waveform data 112, and acoustic features and, in addition, the utterance intention vector provided by unit 96 shown in FIG. 4 as paralinguistic information vector.

As the paralinguistic information vector is attached to each utterance, speech corpus 90 may be called a speech corpus with paralinguistic information vector. Using speech corpus 90 with paralinguistic information vector, it will be possible, in speech synthesis for example, to synthesizing phonetically natural speeches that not only correspond to the text but also bear paralinguistic information reflecting the desired intention of the utterance.

### Third Embodiment

—Configuration—

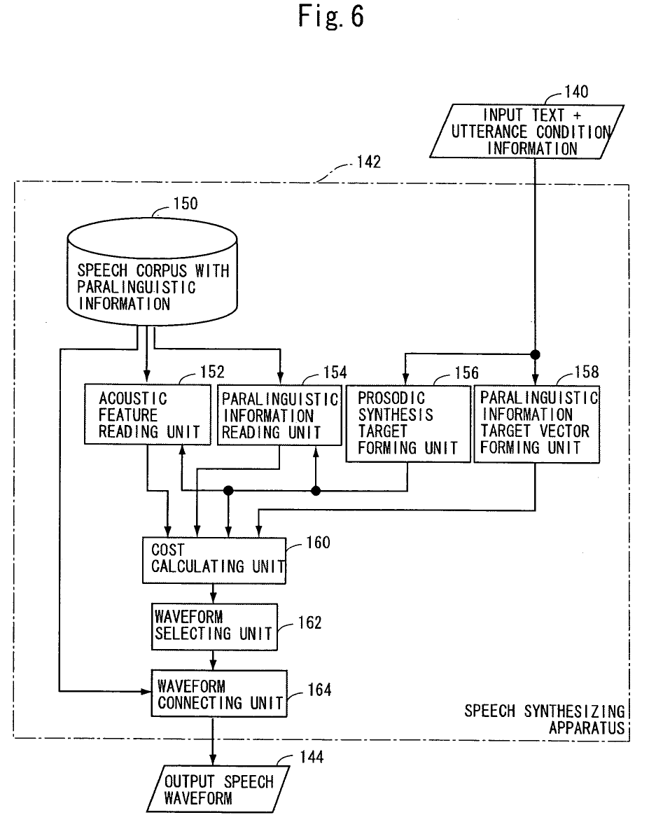

The third embodiment relates to a speech synthesizing apparatus using a speech corpus similar to speech corpus 90 having utterances labeled by speech corpus labeling apparatus 80 in accordance with the second embodiment. FIG. 6 is a block diagram of a speech synthesizing apparatus 142 in accordance with the third embodiment. Speech synthesizing apparatus 142 is a so-called waveform connecting type, having the function of receiving an input text 140 with utterance condition information, and synthesizing an output speech waveform 144 that is a natural speech corresponding to the input text and expressing paralinguistic information (affect) matching the utterance condition information.

Referring to FIG. 6, speech synthesizing apparatus 142 includes: a prosodic synthesis target forming unit 156 for analyzing the input text 140 and for forming a prosodic synthesis target; a paralinguistic information target vector generating unit 158 for generating the paralinguistic information target vector from the utterance condition information included in input text 140; a speech corpus 150 with paralinguistic information vector similar to speech corpus 90 having the paralinguistic information vector attached by speech corpus labeling apparatus 80; an acoustic feature reading unit 152 for selecting waveform candidates from speech corpus 152 that correspond to the outputs of unit 156 and have paralinguistic information vectors, and for reading the acoustic features of the candidates; and a paralinguistic information reading portion 154 for reading the paralinguistic information vectors of the waveform candidates selected by unit 152.

Speech synthesizing apparatus 142 further includes: a cost calculating unit 160 for calculating a cost in accordance with a predetermined equation. The cost is a measure of how much a speech utterance differs from the prosodic synthesis target, how much adjacent speech utterances are discontinuous from each other, and how much the paralinguistic information vector as the target and the paralinguistic information vector of the waveform candidate differ, between combination of the acoustic features of each waveform candidate read by acoustic feature reading unit 152 and the acoustic feature of each waveform candidate read by unit 154, and the combination of the prosodic synthesis target formed by unit 156 and the paralinguistic information vector formed by parahinguistic information target vector forming unit 158. Apparatus 142 further includes a waveform selecting unit 162 for selecting a number of waveform candidates having minimum cost, based on the cost of each waveform candidate calculated by cost calculating unit 160; and a waveform connecting unit 164 reading waveform data corresponding to the waveform candidates selected by waveform selecting unit 162 from speech corpus 150 with paralinguistic information and connecting the waveform data, to provide an output speech waveform 144.

—Operation—

Speech synthesizing apparatus 142 in accordance with the third embodiment operates as follows. Given input text 140, prosodic synthesis target forming unit 156 performs text processing on the input text, forms the prosodic synthesis target, and gives it to acoustic feature reading unit 152, paralinguistic information reading unit 154 and cost calculating unit 160. Paralinguistic information vector forming unit 158 extracts utterance condition information from input text 140, and based on the extracted utterance condition information, forms the paralinguistic target vector, which is applied to cost calculating unit 160.

Acoustic feature reading unit 152 selects waveform candidates from speech corpus 150 and applies them to cost calculating unit 160 with respective paralinguistic information vectors, based on the prosodic synthesis target from unit 156. Likewise, paralinguistic information reading unit 154 reads paralinguistic information vector of the same waveform candidates as read by acoustic feature reading unit 152, and gives the same to cost calculating unit 160.

Cost calculating unit 160 calculates the cost between the combination of the prosodic synthesis target from unit 156 and the paralinguistic information vector from unit 158 and the combination of acoustic features of each waveform candidate applied from unit 152 and the paralinguistic information vector of each waveform applied from unit 154, and outputs the result to waveform selecting unit 162 for each waveform candidate.

Waveform selecting unit 162 selects a prescribed number of waveform candidates with minimum cost based on the costs calculated by unit 160, and applies information representing positions of the waveform candidates in speech corpus 150 with paralinguistic information vector, to waveform connecting unit 164.

Waveform connecting unit 164 reads waveform candidate from speech corpus 150 with paralinguistic information vector based on the information applied from waveform selecting unit 162, and connects the candidate immediately after the last selected waveform. As a plurality of candidates are selected, a plurality of candidates of output speech waveforms are formed by the process of waveform connecting unit 164, and among these, one having the smallest accumulated cost is selected and output as output speech waveform 144 at a prescribed timing.

As described above, speech synthesizing apparatus 142 in accordance with the present embodiment selects waveform candidates that not only match phonemes designated by the input text but also conveys paralinguistic information matching the utterance condition information included in input text 140, and the candidates are used for generating output speech waveform 144. As a result, information that matches the utterance condition designated by the utterance condition information of input text 140 and related to desired affects can be conveyed as paralinguistic information. Each waveform of speech corpus 150 with paralinguistic information vector has a vector attached as paralinguistic information, and the cost calculation among pieces of paralinguistic information is performed as vector calculation. Therefore, it becomes possible to convey contradictory affects or information apparently unrelated to the contents of the input text, as paralinguistic information.

[Computer Implementation]

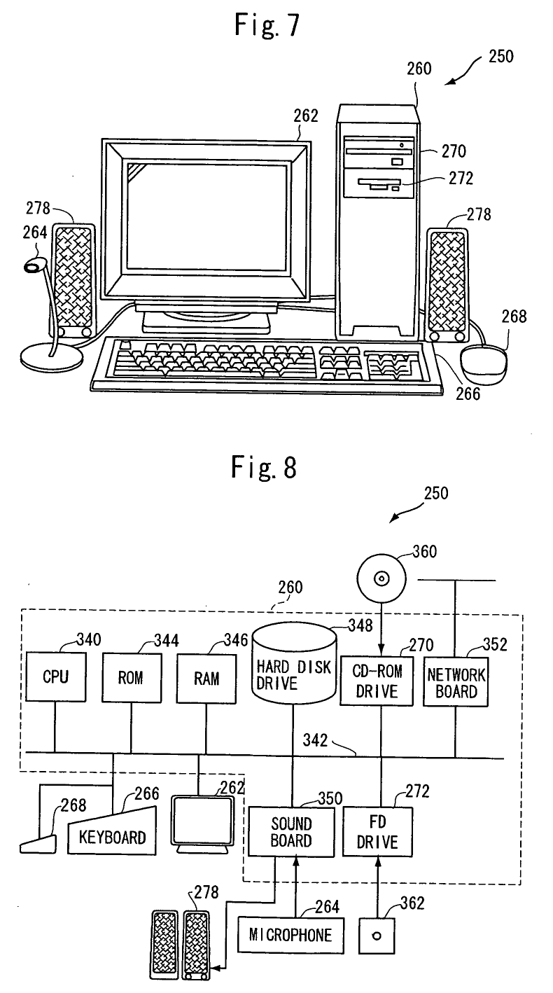

The above-described speech understanding system 20 in accordance with the first embodiment, speech corpus labeling apparatus 80 in accordance with the second embodiment, and speech synthesizing apparatus 142 in accordance with the third embodiment can all be realized by computer hardware, a program executed by the computer hardware and data stored in the computer hardware. FIG. 7 shows an appearance of computer system 250.

Referring to FIG. 7, computer system 250 includes a computer 260 having an FD (Flexible Disk) drive 272 and a CD-ROM (Compact Disc Read Only Memory) drive 270, a keyboard 266, a mouse 268, a monitor 262, a speaker 278 and a microphone 264. Speaker 278 is used, for example, as speaker 32 shown in FIG. 1. Keyboard 266 and mouse 268 are used as input apparatus 34 shown in FIG. 1 and the like.

Referring to FIG. 8, computer 260 includes, in addition to FD drive 270 and CD-ROM drive 270, a CPU (Central Processing Unit) 340, a bus 342 connected to CPU 340, FD drive 270 and CD-ROM drive 270, a read only memory (ROM) 344 storing a boot up program and the like, and a random access memory (RAM) 346 connected to bus 342 and storing a program instruction, a system program, work data and the like. Computer system 250 may further include a pi-inter, not shown.

Computer 260 further includes a sound board 350 connected to bus 342 and to which speaker 278 and microphone 264 are connected, a hard disk 348 as an external storage of large capacity connected to bus 342, and a network board 352 providing connection to local area network (LAN) to CPU 340 through bus 342.

A computer program causing computer system 250 to operate as the speech understanding system 20 or the like described above is stored in a CD-ROM 360 or an FD 362 inserted to CD-ROM drive 270 or FD drive 272, and transferred to a hard disk 348. Alternatively, the program may be transmitted through a network and the network board to computer 260 and stored in hard disk 348. The program is loaded to RAM 346 when executed. The program may be directly loaded to RAM 346 from CD-ROM 360, FD 362 or through the network.

The program includes a plurality of instructions that cause computer 260 to operate as the speech understanding system 20 or the like. Some of the basic functions necessary for the operation are provided by an operating system (OS) running of computer 260 or a third party program, or by modules of various tool kits installed in computer 260. Therefore, the program may not include all the functions necessary to realize the system and method of the present embodiment. The program may include only the instructions that realize the operation of speech understanding system 20, speech corpus labeling apparatus 80 or speech synthesizing apparatus 142, by calling an appropriate function or “tool” in a controlled manner to attain a desired result. How computer 250 works is well known and therefore, detailed description thereof is not given here.

The classification trees in classification tree group 38 of the embodiments described above may be implemented as a plurality of daemons that operate in parallel. In a computer having a plurality of processors, the classification trees may be distributed among the plurality of processors. Similarly, when a plurality of network-connected computers are available, a program that causes a computer to operate as one or a plurality of classification trees may be executed by the plurality of computers. In speech synthesizing apparatus 142 shown in FIG. 6, cost calculating unit 160 may be realized by a plurality of daemons, or by a program that is executed by a plurality of processors.

Although phonemes are labeled with paralinguistic information vectors in the above-described embodiments, the invention is not limited to that. Any other speech unit, such as syllable, may be labeled with paralinguistic information vectors.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. A speech processing apparatus, comprising:
a statistics collecting module operable to collect, for each of a prescribed utterance units in a training speech corpus, a prescribed type of acoustic feature and statistic information on a plurality of predetermined paralinguistic information labels being selected by a plurality of listeners to speech corresponding to the utterance unit; and
a training apparatus trained by supervised machine training using said prescribed acoustic feature as input data and using the statistic information as answer data, said training apparatus being operable to output probabilities of the labels being allocated to a given acoustic feature.

2. The speech processing apparatus according to claim 1, wherein
said statistics collecting module includes
a module for calculating a prescribed type of acoustic feature for each of the prescribed utterance units in the training speech corpus;
a speech reproducing apparatus for reproducing speech corresponding to the utterance unit for each of the prescribed utterance units of speech in said training speech corpus;
a label specifying module for specifying a paralinguistic information label allocated by a listener to the speech reproduced by said speech reproducing apparatus; and
a probability calculation module for calculating, for each of said plurality of paralinguistic information labels, probability of said each of said plurality of paralinguistic information labels being allocated to said prescribed utterance units of a speech in said training corpus, by reproducing, for each of a plurality of listeners, a speech by said speech reproducing apparatus and specification of paralinguistic information label by said label specifying module.

3. The speech processing apparatus according to claim 2, wherein
said training apparatus includes a plurality of classification trees provided corresponding to said plurality of paralinguistic information labels, wherein each of the classification trees being able to be trained using said prescribed acoustic feature as input data and the probability calculated by said probability calculation module for corresponding one of the paralinguistic information labels as training data, to output a probability of allocation of the corresponding paralinguistic information label in response to the prescribed acoustic feature.

4. The speech processing apparatus according to claim 1, wherein said prescribed utterance unit is a syllable.

5. The speech processing apparatus according to claim 1, wherein said prescribed utterance unit is a phoneme.

6. A speech processing apparatus, comprising:
an acoustic feature extracting module operable to extract a prescribed acoustic feature from an utterance unit of an input speech data;
a paralinguistic information output module operable to receive the prescribed acoustic feature from said acoustic feature extracting module and to output a value corresponding to each of a predetermined plurality of types of paralinguistic information as a function of the acoustic feature; and
an utterance intention inference module operable to infer utterance intention of a speaker related to said utterance unit of said input utterance data, based on a set of values output from said paralinguistic information output module.

7. The speech processing apparatus according to claim 6, wherein
the value corresponding to each of said plurality of types of paralinguistic information output from said paralinguistic information output module forms a paralinguistic information vector; and
said utterance intention inference module includes
a speech recognition apparatus operable to perform speech recognition on said input speech data, and
a meaning understanding module operable to receive as inputs the result of speech recognition by said speech recognition apparatus and paralinguistic information vector output by said paralinguistic information output module for each utterance unit of said input speech data, and to output a result of inferred semantic understanding of said input speech data.

8. The speech processing apparatus according to claim 6, wherein said prescribed utterance unit is a syllable.

9. The speech processing apparatus according to claim 6, wherein said prescribed utterance unit is a phoneme.

10. A speech processing apparatus, comprising:
an acoustic feature extracting module operable to extract, for each of prescribed utterance units included in a speech corpus, a prescribed acoustic feature from acoustic data of the utterance unit;
a paralinguistic information output module operable to receive said acoustic feature extracted for each of said prescribed utterance units from said acoustic feature extracting module, and to output, for each of a predetermined plurality of types of paralinguistic information labels, a value as a function of said acoustic feature; and
a paralinguistic information addition module operable to generate a speech corpus with paralinguistic information, by additionally attaching a value calculated for each of said plurality of types of paralinguistic information labels by said paralinguistic information output module to the acoustic data of the utterance unit.

11. The speech processing apparatus according to claim 10, wherein said prescribed utterance unit is a phoneme.

12. A speech processing apparatus, comprising:
a speech corpus including a plurality of speech waveform data items each including a value for each of a prescribed plurality of types of paralinguistic information labels, a prescribed acoustic feature including a phoneme label, and speech waveform data;
waveform selecting module operable to select, when a prosodic synthesis target of speech synthesis and a paralinguistic information target vector having an element of which value is determined in accordance with an intention of utterance are applied, a speech waveform data item having such acoustic feature and paralinguistic information vector that satisfy a prescribed condition determined by said prosodic synthesis target and said paralinguistic information target vector, from said speech corpus; and
a waveform connecting module operable to output a speech waveform by connecting the speech waveform data included in the speech waveform data item selected by said waveform selecting module in accordance with said synthesis target.

13. The speech processing apparatus according to claim 12, further comprising
a synthesis target forming module operable to form, when a text as a target of speech synthesis and utterance intention information representing intention of utterance of the text are applied, a prosodic synthesis target of speech synthesis based on said text, further to form said paralinguistic information target vector based on said utterance intention information, and to apply said prosodic synthesis target and said paralinguistic information target vector to said waveform selecting module.

14. A speech processing method, comprising the steps of:
collecting, for each of a prescribed utterance units of a speech in a training speech corpus, a prescribed type of acoustic feature and statistic information on a plurality of predetermined paralinguistic information labels being selected by a plurality of listeners to a speech corresponding to the utterance unit; and
training, by supervised machine training using said prescribed acoustic feature as input data and using the statistic information as answer data, to output probabilities of the labels being allocated to a given acoustic feature for each of said plurality of paralinguistic information labels.

15. The speech processing method according to claim 14, wherein
said collecting step includes the steps of
calculating a prescribed type of acoustic feature for each of the prescribed utterance units in the training speech corpus;
reproducing, for each of prescribed utterance units of a speech in said training speech corpus, a speech corresponding to the utterance unit;
specifying a paralinguistic information label allocated by a listener to the speech reproduced in said reproducing step; and
calculating, for each of said plurality of paralinguistic information labels, probability of said each of said plurality of paralinguistic information labels being labels allocated to said prescribed utterance units of a speech in said training corpus, by reproducing, for each of a plurality of listeners, a speech in said speech reproducing step and specification of paralinguistic information label in said label specifying step.

16. The speech processing method according to claim 15, wherein
said training step includes the step of training a plurality of classification trees provided corresponding to said plurality of paralinguistic information labels, wherein each of the classification trees being able to be trained using said prescribed type of acoustic feature as input data and the probability calculated in said probability calculating step as answer data, to output in response to an acoustic feature a probability of allocation of the corresponding paralinguistic information label.

17. The speech processing method according to claim 14, wherein said prescribed utterance unit is a phoneme.

18. A speech processing method, comprising the steps of:
extracting a prescribed acoustic feature from an utterance unit of an input speech data;
applying said prescribed acoustic feature extracted in said step of extracting, to a paralinguistic information output module operable to output a value for each of a predetermined plurality of types of paralinguistic information as a function of the acoustic feature, to obtain a value corresponding to each of said plurality of types of paralinguistic information; and
inferring, based on a set of values obtained in said step of obtaining, intention of utterance by a speaker related to said utterance unit of said input speech data.

19. The speech processing method according to claim 18, wherein
the values corresponding to said plurality of types of paralinguistic information forms a paralinguistic information vector; and
said step of inferring intention includes the steps of
performing speech recognition on said input speech data, and
inferring a result of semantic understanding of said input speech data, using a result of speech recognition in said step of speech recognition and the paralinguistic information vector obtained in said step of obtaining the value for each utterance unit of said input speech data.

20. The speech processing method according to claim 19, wherein said prescribed utterance unit is a syllable.

21. The speech processing method according to claim 19, wherein said prescribed utterance unit is a phoneme.

22. A speech processing method, comprising the steps of:
extracting, for each of prescribed utterance units included in a speech corpus, a prescribed acoustic feature from acoustic data of the utterance unit;
receiving said acoustic feature extracted for each of said prescribed utterance units in said extracting step, and calculating, for each of a predetermined plurality of types of paralinguistic information labels, a value as a function of said acoustic feature; and
generating a speech corpus with paralinguistic information, by attaching, for every said prescribed utterance unit, the value calculated for each of said plurality of types of paralinguistic information labels calculated in said calculating step to acoustic data of the utterance unit.

23. The speech processing method according to claim 22, wherein said prescribed utterance unit is a phoneme.

24. A speech processing method, comprising the steps of:
preparing a speech corpus including a plurality of speech waveform data items each including a value corresponding to each of a prescribed plurality of types of paralinguistic information labels, a prescribed acoustic feature including a phoneme label, and speech waveform data;
in response to a prosodic synthesis target of speech synthesis and a paralinguistic information target vector having an element of which value is determined in accordance with utterance intention, selecting a speech waveform data item having such acoustic feature and paralinguistic information vector that satisfy a prescribed condition determined by said prosodic synthesis target and said paralinguistic information target vector, from said speech corpus; and
connecting speech waveform data included in the speech waveform data item selected in said selecting step in accordance with said synthesis target, to form a speech waveform.

25. The speech processing method according to claim 24, further comprising the step of
in response to a text as a target of speech synthesis and utterance intention information representing intention of utterance of the text, forming a prosodic synthesis target of speech synthesis based on said text and forming said paralinguistic information target vector based on said utterance intention information, and applying said prosodic synthesis target and said paralinguistic information target vector as inputs in said selecting step.
